(19) United States
(12) Patent Application Publication
(10) Pub. No.: US 2008/0099078 A1
(43) Pub. Date: May 1, 2008

(54) Apparatus for a removable and replaceable insulation element for valves and fittings and method therefor

(76) Inventor: Mike Heatwole, Canadian, TX (US)

Correspondence Address: Samuel Brown Silverman, Esq.;Attorneys at Law, Silverman & Silverman, 510 South Polk Street, Amarillo, TX, 79101-2318, US

(21) Appl. No.: 11/588,709

(22) Filed: Oct. 27, 2006

(51) Int. Cl. F16L 7/00

(52) U.S. Cl. 137/375

(57) ABSTRACT

The apparatus of the invention consists of a flexible enclosure component with a top, a bottom, at least one side and an interior space. Fill element is contained in the interior of the enclosure component and is conformable to the shapes and contours the flexible enclosure component assumes.

The method of the invention consists of employing one or more of the apparatus as described in a the cavity dedicated to encasing valve and control mechanisms and filling the space in the cavity to the exclusion of any other material that may otherwise fill the cavity.

### 1. FIELD OF THE INVENTION

The present invention pertains to an apparatus with a flexible enclosure, containing a fill element for valves and fittings, in particular underground sprinkler control valves contained in a cavity.

### 2. DISCLOSURE DOCUMENT REFERENCE

Disclosure Document Number 572743, entitled, REMOVABLE INSULATION ELEMENT FOR VALVES AND FITTINGS, filed Mar. 14, 2005.

### 3. BACKGROUND OF THE INVENTION

In certain aspects, this invention relates to readily removable thermal insulation and space occupying elements for valves and other fittings for non-modular design.

Sprinkler system valves control the flow of fluid, namely water and other hydration solutions. These valves may be the backflow type, which prevent the contamination of the source supply line, or any of a variety of other valves, switches or other control means for irrigation purposes.

Four problems pertain to: (1) the accumulation of dirt and debris in the cavity encasing the valves and control mechanisms; (2) inconvenience of digging around and consequent damage to the equipment being excavated during maintenance; (3) the damage caused by the accumulation of upwelled dirt and soil, insects, and vermin in and around the underground equipment; and, (4) variations in both the depth and temperature of the valves or control mechanisms to be protected.

Currently available art does not satisfactorily address any of these common problems. Valves and control mechanisms are installed in underground cavities to satisfy certain safety or aesthetic concerns. As a result of the underground placement of these valves and controls, dirt and debris accumulates, either from falling into the cavity or from upwelling from the ground beneath. Insects and vermin, which are also attracted to the confines of the underground equipment, cause more dirt and debris to accumulate in the cavity. When the underground equipment requires frequent maintenance and repair, a great deal of time and effort is expended just in the excavation and removal of the accumulated dirt and debris.

Additionally, it is common knowledge and accepted by those familiar with the art that valves frequently need repair. In exteremely adverse conditions, that not only makes servicing the valve or control equipment difficult to safely access, but may occasion damage to the equipment. While most fluid simply leaked simply drains into the exposed ground beneath the equipment, the accumulated water or fluid need not be solid. While the heat from the soil,even at a shallow depth, and the modest heat associated with water under pressure is usually sufficient to keep the accumulated water from freezing, the free movement of air, or exposure to cold air permits the undesirable freezing to occur.

When conditions are adverse, sometimes it is desirable to make access to the equipment as quickly and easily as possible. Being able to minimize the exposure of the wires, valves, seals and fittings to the adverse effects of contact with soil, vermin, insects and ice decreases the effort required to effect repairs. Prior to this invention, such an ability was not commonly available. This invention addresses these previously unaddressed problems in a cost effective and satisfactory manner.

### 4. DESCRIPTION OF RELATED ART

No prior art apparatuses address specifically the structure of the apparatus or method of this invention. Insulating elements employed to protect valves have different structures. Soil-replacement or ground-filling structures described neither address the specific problem to be addressed nor suggest the specific structure of this invention. Water-permeable bag elements used for erosion control or as filters neither suggest nor teach the specific structure and use of this invention. While the prior art disclosed and discussed below each disclose a structural aspect of the invention, no one prior art reference anticipates the apparatus or method of this invention.

U.S. Pat. No. 4,556,082 (Riley et al.) is a unitary flexible removable thermal insulation jacket for valves and fittings. A substantially flat insulated element wraps around a valve and held in place with draw cords.

U.S. Pat. No. 4,112,967 (Withem) is a valve cover for a pipe line with a flexible multi-layered shape with an outer layer of herculite.

U.S. Pat. No. 6,206,030 (Barthuly) is an apparatus and method employing an insulating cover for a ground-level water backflow prevention apparatus. An open-bottomed insulated bag is placed over a valve; ballast near the open end of the bag holds the cover in place. In certain embodiments, tabs and stakes are other means for holding the bag in place; in one embodiment, the bag is electrically heated.

U.S. Pat. No. 6,991,408 (Bottriel et al.) is a bag containing a non-water retaining, non-biodegradable soil replacement material. The bag may be a mesh material. The apparatus is used against foundations, walls or piers in lieu of backfill.

U.S. Pat. No. 6,547,493 (Spangler) is a modular erosion and sediment control barrier constructed of fiber logs comprised of loose material in tubular casings.

U.S. Pat. No. 5,584,599 (Knittel) is a modular barrier system of interconnecting water-retaining and impact-absorbing sandbags.

U.S. Pat. No. 5,385,430 (Connonrs) is a pipeline ballasting device. The interior walls of the containment device confine ballast material and a pipeline. The ballast material is contained in an envelope, which in turn confines position of the pipeline within the containment device.

U.S. Pat. No. 4,986,699 (Bohnhoff) is a soil filtration and water drainage device. A pillow contains a plurality of elongated, rounded, non-compressible, water-resistant and non-biodegradable pellets generally of a specific density range contained in a water-permeable membrane. Water passes through the pillow and prevents the drainage or passage of soil, silt and algae.

U.S. Pat. No. 6,315,493 (Malone et al.) is a retrievable filter element for subsurface drainage into leach fields. Water-permeable net sacks filled with scrap rubber or plastic chips are placed above and below a drain pipe in a ditch. Soil is placed atop the upper layer of net sacks.

U.S. Pat. No. 6,368,499 (Sharpless) is a storm drain assembly with a disposable filter cartridge. The filter cartridge is a water-permeable pillow structure containing a quantity of loose, oil-absorbing fibers.

U.S. Pat. No. 4,983,068 (Kozak et al.) is a construction bag for use in soil erosion applications for draining roadbeds and construction footings. A tubular water-permeable bag is filled with crushed scrap glass.

U.S. Pat. No. 6,109,835 (Grabhorn) is an apparatus comprising biofilter bags placed on or near the ground surface for erosion control. A water-permeable bag with a flexible mesh wall is filled with hammer-milled wood fragments.

U.S. Pat. No. 4,269,890 (Breitling et al.) describes a process and apparatus for introducing foam into automobile cavities. An empty bag is introduced into a cavity, and then subsequently filled with foam.

U.S. Pat. No. 5,577,688 (Sloan) describes a process and apparatus for introducing foam into aircraft fuselage wall cavities. An empty bag is introduced into a cavity, and then subsequently filled with a moisture impervious material. Air flow out of the bags when the cabin is under pressure permits the removal of any condensate from the insulating element.

U.S. Pat. No. 4,399,645 (Murphy et al.) describes a method for introducing insulation into wall cavities. A bladder or impervious bag is inflated within a wall cavity, and then subsequently filled with insulating material.

U.S. Pat. No. 5,379,568 (Murray) describes a method and apparatus for introducing loose-fill insulation into wall cavities. A bag positioned in an adjustable wall form; the bag, after being filled with insulating material, is placed in the wall of the building.

U.S. Pat. Nos. 3,889,743 and 3,730,240 (Presnick) are inflatable insulation for packaging. Inflatable thermoplastic bags are used to fill space within a box or package.

U.S. Pat. No. 6,390,154 (Hall) is an apparatus and method for a portable levee system employing a fillable bag of a certain geometric structure, with fill material to be dispensed into a bag. In certain embodiments, the bags are to be connectable to other bags.

### 5. SUMMARY OF THE INVENTION

The apparatus of this invention is a removable insulation element for valves and fittings being a flexible enclosure component with a top, a bottom, and at least one side, and an interior. In the interior is a fill element, which is conformable to the shapes and contours of the flexible enclosure component.

### 6. BRIEF DESCRIPTION OF THE DRAWINGS

FIG. 1 is a front perspective view of one preferred embodiment of the invention in a cavity.

FIG. 2 is a side view of the apparatus of the invention.

FIG. 3 is top view of the apparatus of the invention.

### 7. DESCRIPTION OF CERTAIN PREFERRED EMBODIMENTS

As illustrated in the figures, the apparatus (10) of the invention comprises a flexible enclosure component (11) with a top (12), a bottom (13), at least one side (14) and an interior space (15). Fill element (20) is contained in the interior (15) of the enclosure component (11). Fill element (20) is conformable to the shapes and contours the flexible enclosure component (20) assumes.

In certain embodiments, the apparatus (10) of this invention is a removable and replaceable insulation element for valves and fittings. The apparatus consists of a flexible enclosure component (11) containing a fill element (20).

The flexible enclosure component (11) has a top (12), a bottom (13), at least one side (14), an exterior (16) and an interior space (15).

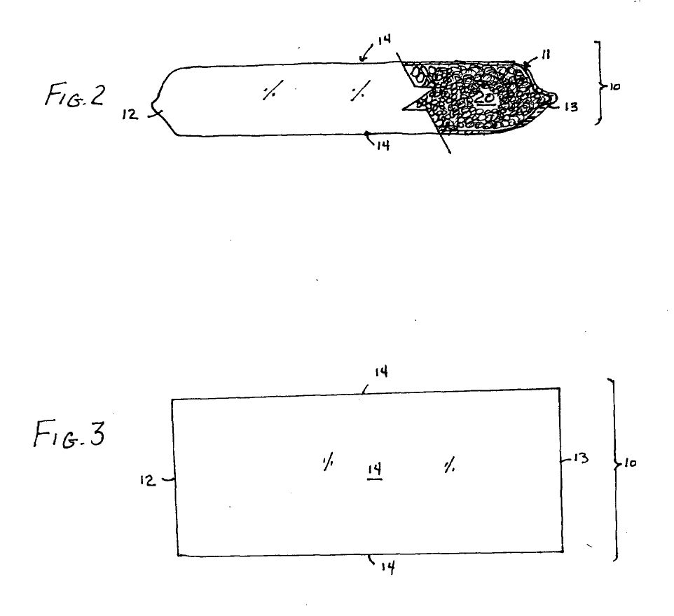

In certain embodiments, the flexible enclosure component (11) is generally rectangular and may be elongated, as illustrated in FIG. 2. It is contemplated that a variety of shapes may be employed to adapt to a variety of applications and environments. Because the cavity for an underground sprinkler control cavity is generally rectangular or trapezoidal, it would be appropriate to make the flexible enclosure component (11) rectangular, trapezoidal, triangular or even elliptical or circular in cross-section.

In certain embodiments, the flexible enclosure component (11) is contemplated to be made of a continuous plastic surface, woven fabric of suitable fiber, including nylon, or other durable and flexible material suitable for the environment of the cavity in which valves and other control mechanisms are located.

In certain embodiments of the invention, the flexible enclosure component (11) is moisture permeable. In these certain embodiments, however, the fill element (20) is not made of a non-biodegradable polymer material, including specifically, polyethylene, polypropylene, polystyrene, polyvinyl chloride, or polyester.

In certain other embodiments of the invention, the flexible enclosure component (11) is moisture impermeable. Because the function of the apparatus of this invention is to occupy the space in the, generally underground, cavity in which valves and other control mechanisms are located, it is preferred that the apparatus easily fill the volume of the space while also having sufficient weight and density to prevent the upwelling of soil from beneath the valves and otherwise deter the entrance of other material, such as leaves, dirt, grass or other ground-borne material, from either the sides or the top of the cavity in which valves and other control mechanisms are located. In these certain other embodiments of the invention, wherein the flexible enclosure component (11) is moisture impermeable, the fill element (20) is not adversely affected by the introduction of moisture or other contaminants. Contaminated or moistened fill element (20) may adversely affect the flexibility or malleability of the apparatus (10) when in use. Unlike prior art which describes structures permanently buried, the apparatus of this invention is easily removable and replaceable, thus requiring a flexible enclosure component (11) which protects the fill material (20) from contamination for repeated replacement such that the fill material (20) retains its malleable qualities.

In these certain other embodiments of the invention, wherein the flexible enclosure component (11) is moisture impermeable, the flexible enclosure component (11) may be made of a non-biodegradable polymer material, including specifically, polyethylene, polypropylene, polystyrene, polyvinyl chloride, polyester or polyvinyl fluoride film.

In each embodiment of this invention, the top (12) is closed. Distinct from related prior art that teaches an open top, the apparatus of this invention employs a top (12) which is closed.

The at least one side (14) is closed. Distinct from prior art which teaches an openable side, the apparatus of this invention employs at least one side (14) which is closed.

The fill element (20) is located within the interior space (15) of the enclosure element (11). The fill element (20) conforms to the shapes and contours of the flexible enclosure element (11).

In certain embodiments of the invention, the fill element (20) may be a low-density material, a high-density material, a liquid, a semi-solid or a gas. A low density material would include a non-polymeric foam, non-polymeric beads, hollow metal beads, or hollow ceramic beads, or other suitable material. A high-density material would include sand, lead shot or lead granules, metal shavings, or ceramic beads, or other suitable like material. A semi-solid fill element may include a non-reactive gelatinous material, such as silicone gel, or other suitable like material.

In certain embodiments of the invention in which the flexible enclosure component (11) is moisture impermeable, the fill element (20) is non-biodegradable. In these embodiments, the fill element (20), polymer materials may be employed. Suitable polymer materials include polyethylene, polypropylene, polystyrene, polyvinyl chloride, and polyester.

In the certain embodiments of the invention in which the flexible enclosure component (11) is moisture impermeable, the fill element (20) may be a non-polymer solid materials may be employed, including sand, silicate beads, ceramic, metal, and organic compounds, including specifically treated nuts, shells, and cotton bolls and fibers.

In those certain embodiments in which the flexible enclosure component (11) is moisture permeable, the fill element (20) is biodegradable. In these other certain embodiments wherein the fill element (20) is biodegradable, materials employed may include organic compounds, such as nuts, shells, cotton, beans, etc. In these certain embodiments in which the flexible enclosure component (11) is moisture permeable, however, the fill element (20) is not made of a non-biodegradable polymer material, including specifically, polyethylene, polypropylene, polystyrene, polyvinyl chloride, or polyester. In these same certain embodiments in which the flexible enclosure component (11) is moisture permeable, however, the fill element (20) may be non-biodegradable, but non-polymer solid materials, such as sand, silicate beads, ceramic, metal, and organic compounds. In these same certain embodiments in which the flexible enclosure component (11) is moisture permeable, however, the fill element (20) may include a desiccant to absorb and retain water or moisture.

In those embodiments of the invention employing non-biodegradable materials for the fill element (20), the non-biodegradable material may be comprised of plastics and may additionally incorporate other suitable materials made from paper as well as polymeric materials or other suitable recycled composite materials.

In certain embodiments of the invention, the fill element (20) comprises irregularly shaped elements. In certain other embodiments of the invention, the fill element (20) comprises elements without apertures.

The method of this invention addresses the filling of space in a cavity dedicated to encasing valve and control mechanisms. The first step involves employing or providing providing at least one removable and replaceable insulation element for valves and fittings. Each at least one removable and replaceable insulation element for valves and fittings has a flexible enclosure component, with a top, a bottom, at least one side, an exterior, and an interior space, and a fill element, located within the interior space of the enclosure component and conformable to the shapes and contours of the enclosure component. The second step entails positioning the at least one removable and replaceable insulation element for valves and fittings in the cavity dedicated to encasing valve and control mechanisms. The third step requires filling the space in the cavity dedicated to encasing valve and control mechanisms with the at least one removable and replaceable insulation element for valves and fittings to the exclusion of any other material, namely dirt, debris, or detritus from occupying the cavity.

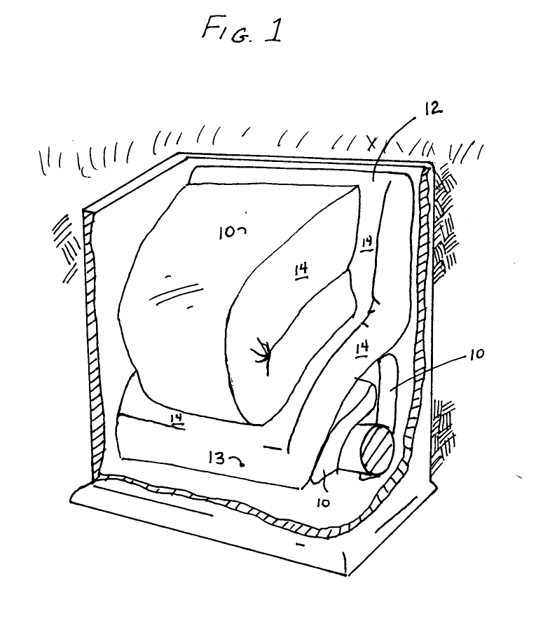

The present invention is a removable insulation element for valves and fittings consisting of a unitary, non-modular design. The flexible enclosure component (11) is adapted to assume a substantially flat configuration before application. As illustrated in FIG. 1, the flexible enclosure component (12) of this invention readily conforms to the contours of the valves and mechanisms in the cavity, as well as the cavity itself. The non-modular design results from the use of shape-conforming fill material in the fill element (20).

In use, this invention is placed in the cavity encasing valves and control mechanisms. The flexible aspect of this invention addresses the need to fit within the space allotted and around the equipment to be protected. Because different cavities, or spaces, differ in size and geometry, the variety and shapes of the different embodiments of the apparatus (10) of this invention would vary.

It is therefore the primary object of this invention to provide a universal element for filling the underground space or cavity encasing the valves and control mechanisms, regardless of the type and size of the cavity, or equipment enclosed therein, in order to prevent the undesired accumulation of dirt and debris in the cavity encasing the valves and control mechanisms.

Another object of this invention is, in certain embodiments, to provide a thermal insulation means which is easily installed and easily removed from the cavity encasing the valves and control mechanisms, thus avoiding the inconvenience of excavating and potentially damaging, sensitive equipment in the course of maintenance.

Another object of this invention is to prevent damage caused by the contact of soil, insect, vermin and dirt on, around, or even in, underground valves and control mechanisms.

I claim:

1. A removable and replaceable insulation element for valves and fittings, comprising:
a flexible enclosure component, with
a top,
a bottom,
at least one side,
an exterior, and
an interior space, and
a fill element
located within the interior space of the enclosure component and
conformable to the shapes and contours of the enclosure component.

2. The apparatus of claim 1 wherein the flexible enclosure component is moisture impermeable.

3. The apparatus of claim 2 wherein the fill element is non-biodegradable.

4. The apparatus of claim 2 wherein the fill element is non-biodegradable and made of a non-biodegradable polymeric material.

5. The apparatus as set forth in claim 4, wherein said polymeric material is selected from a group consisting of polyethylene, polypropylene, polystyrene, polyvinyl chloride, and polyester.

6. The apparatus of claim 1 wherein the flexible enclosure component is moisture permeable.

7. The apparatus of claim 6 wherein the fill element is biodegradable.

8. The apparatus of claim 6 wherein the fill element is not made of a polymeric material, selected from a group consisting of polyethylene, polypropylene, polystyrene, polyvinyl chloride, and polyester.

9. The apparatus of claim 6 wherein the fill element is a desiccant.

10. The apparatus of claim 1 wherein the fill element is a high-density material.

11. The apparatus of claim 1 wherein the fill element is a low-density material.

12. The apparatus of claim 1 wherein the fill element is a liquid.

13. The apparatus of claim 1 wherein the fill element is a semi-solid.

14. The apparatus of claim 1 wherein the fill element is a gas.

15. The apparatus of claim 1 wherein the fill element comprises irregularly shaped elements.

16. The apparatus of claim 1 wherein the fill element comprises elements without apertures.

17. A method for filling a space in a cavity dedicated to encasing valve and control mechanisms, comprising:
providing at least one removable and replaceable insulation element for valves and fittings, each at least one removable and replaceable insulation element for valves and fittings having
a flexible enclosure component, with
a top,
a bottom,
at least one side,
an exterior, and
an interior space, and
a fill element
located within the interior space of the enclosure component and
conformable to the shapes and contours of the enclosure component;
positioning the at least one removable and replaceable insulation element for valves and fittings in the cavity dedicated to encasing valve and control mechanisms; and, filling the space in the cavity dedicated to encasing valve and control mechanisms with the at least one removable and replaceable insulation element for valves and fittings to the exclusion of any other material, namely dirt, debris, or detritus from occupying the cavity.
